(19) United States
(12) Patent Application Publication
(10) Pub. No.: US 2010/0064317 A1
(43) Pub. Date: Mar. 11, 2010

(54) METHOD AND APPARATUS FOR PLAYING BACK A PROGRAM

(75) Inventors: Jun Shi, Shanghai (CN); Jingwei Tan, Shanghai (CN); Liang Gan, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,044

(22) PCT Filed: Dec. 5, 2005
(86) PCT No.: PCT/IB05/54040

§ 371 Date: Oct. 14, 2009

(30) Foreign Application Priority Data
Dec. 9, 2004 (CN) 200410101969.4

(51) Int. Cl. H04N 5/445; H04N 5/91; H04N 7/173; H04N 5/50

(52) U.S. Cl. 725/39; 386/95; 386/68; 725/109; 725/110; 348/731; 348/E05.097; 386/E05.003

(57) ABSTRACT

This invention provides a method and apparatus for playing back a program, and the program is being broadcast. Firstly, receiving a request on the program being broadcast for playing back a section of the program in non-real-time mode from a subscriber; acquiring a corresponding internet address according to information in the broadcast signal of the program; and obtaining the section according to the internet address for playing back; and finally, playing back the section. The request includes one of the following commands: pause, fast winding, fast rewinding, rewinding, and playing back at designated non-real time point. During the broadcast of a program, the present invention obtaining a section of the program in a non-real time mode by acquiring an internet address corresponding to the program and in the stream media form.

### BACKGROUND OF THE INVENTION

This invention relates to method and apparatus for playing back a program, in particular to method and apparatus for playing back a broadcast program.

With the wide application and popularization of the digital television programs, the contents, categories and channels of programs are constantly enriching. These programs can be transmitted to subscribers' terminal by means of territorial, cable or satellites to satisfy their varied choice. However, it is exactly this extreme enrichment and limited time of subscribers' that have made it increasingly difficult for subscribers to tune in a particular program. They may miss their favorite programs for various reasons.

To facilitate subscribers to search programs, the Electronic Programming Guide (EPG) has been used to provide them with the available information. An ordinary EPG is a two-dimensional grid, one axis of which is the program time, the other of which the program channel or program provider, and the contents of which are the program information, such as titles of the program provided on different channels at different time period. A subscriber can get to know the program information being, having been and to be broadcast by a particular channel with the EPG.

With the wide spread of the Personal Video Recorder (PVR), the Personal Digital Recorder (PDR) has also been more and more widely used. With the PDR, a subscriber may record his favorite program for future use. For example, there will be a English Superball match tomorrow afternoon, but the subscriber has no time to watch it at the time. He can use the PDR to record the program and watch it in his spare time.

The US patent application (disclosure No. US2003/0177495A1; inventor: Bradford H. Needham, et, al; and the date of filing: 12 Mar. 2002) has disclosed an Electronic Programming Guide for facilitating subscribers to get a copy of the program he chooses. The EPG contains a list of a plurality of programs. The list includes a previously broadcast program which can be downloaded to a subscriber's recording device; it also includes programs being broadcast, which can be downloaded to a subscriber's recording device; it also includes programs to be broadcast which can be downloaded to a subscriber's recording device. The EPG, in combination with transmitted broadcast program contents with video request, has resolved the problem of how subscribers obtain programs that have been broadcast.

While the US patent has resolved the problem of how subscribers obtain programs that have been broadcast to a certain extent, the method requires occupying a subscriber's memory space. Besides, it remains a problem how a program being broadcast coordinates with the part having broadcast and that being broadcast.

Therefore, a new method and apparatus for playing back a program are needed to enable subscribers to do the random or seamless switch between the part broadcast and that being broadcast of a program that has been broadcast to give them a better viewing experience.

### OBJECT AND SUMMARY OF THE INVENTION

One of the objects of the present invention is to provide a method and apparatus for playing back a program to enable subscribers to do the random or seamless switch between the part broadcast and that being broadcast of a program that has been broadcast to give them a better viewing experience.

The present invention provides a method for playing back a program. Firstly, receiving a request on the program being broadcast for playing back a section of the program in non-real-time mode from a subscriber; acquiring a corresponding internet address according to information in the broadcast signal of the program; and obtaining the section according to the internet address for playing back; and finally, playing back the section. The request includes one of the following commands: pause, fast winding, fast rewinding, rewinding, and playing back at designated non-real time point.

One embodiment of the present invention is that the non-real time broadcast section precedes the current time point of the program being broadcast, and the request is for fast winding from a non-real time point designated. In this case, when the request is fast winding from designated time point, comparing current time point of playing back the section with the current time point of the program being broadcast; if the comparison results are equivalent, playing back the program from broadcast signal.

When a program is being broadcast, the present invention, through acquiring an internet address related to the program and acquiring a non-real time broadcast section of the program in a stream media form, realizes the random or seamless switch between the part broadcast and that being broadcast of a program that has been broadcast. And a subscriber does not feel the difference in the source of the program as if he were operating a locally stored program.

Another example of the present invention is that the non-real time playback fees are calculated according to the length of time for the playback of said section. The rate of fees for non-real time playback is different from that for broadcast playback. In case like this, the broadcast service provider can charge a lower rate of fees for programs transmitted through broadcast signals, and charge a higher rate of fees for programs transmitter on the internet to provide value-added services.

The present invention has also provided An apparatus for playing back a program, comprising: means for receiving a request on the program being broadcast for playing back a section of the program in non-real-time mode from a subscriber; means for acquiring a corresponding internet address according to information in the broadcast signal of the program; and means for obtaining the section according to the internet address for playing back.

According to another example of the present invention, the program playback apparatus also includes means for monitoring the current playback time point of the non-real time program and that of the program being broadcast so as to resume the normal broadcast playback at a particular time point.

The present invention also provides a set-top box, which includes a tuner for receiving a broadcast signal containing a program; an apparatus for playing back the program, comprising: means for receiving a request on the program being broadcast for playing back a section of the program in non-real-time mode from a subscriber; means for acquiring a corresponding internet address according to information in the broadcast signal of the program; and means for obtaining the section according to the internet address for playing back; means for switching between the tuner and the internet content acquisition means; and a decoder for decoding the program and the non-real time program section.

The present invention also provides a television set, which comprises a tuner for receiving a broadcast signal containing a program; an apparatus for playing back the program, comprising: means for receiving a request on the program being broadcast for playing back a section of the program in non-real-time mode from a subscriber; means for acquiring a corresponding internet address according to information in the broadcast signal of the program; and means for obtaining the section according to the internet address for playing back; means for switching between the tuner and the internet content acquisition means; and a decoder for decoding the program and the non-real time program section; means for presenting decoded program and section.

The other objects and achievements of the present invention will be made more evident, and the present invention be more comprehensively understandable by virtue of the following description and claims with reference to the appended drawings.

### DESCRIPTION OF THE DRAWINGS

The present invention is explained in detail by way of examples and with reference to the drawings, which comprises:

FIG. 1 is an block diagram of the components of an apparatus for playing back a program according one example of the present invention;

FIG. 2 is a flow chart of playback of a program according to another example of the present invention;

FIG. 3 is an block diagram of the components of a television set-top box according to another example of the present invention; and

FIG. 4 is an block diagram of the components of a television set according to anther example of the present invention.

The same reference numbers in the Figures indicate the similar or identical features and functions.

### DETAILED DESCRIPTION OF THE INVENTION

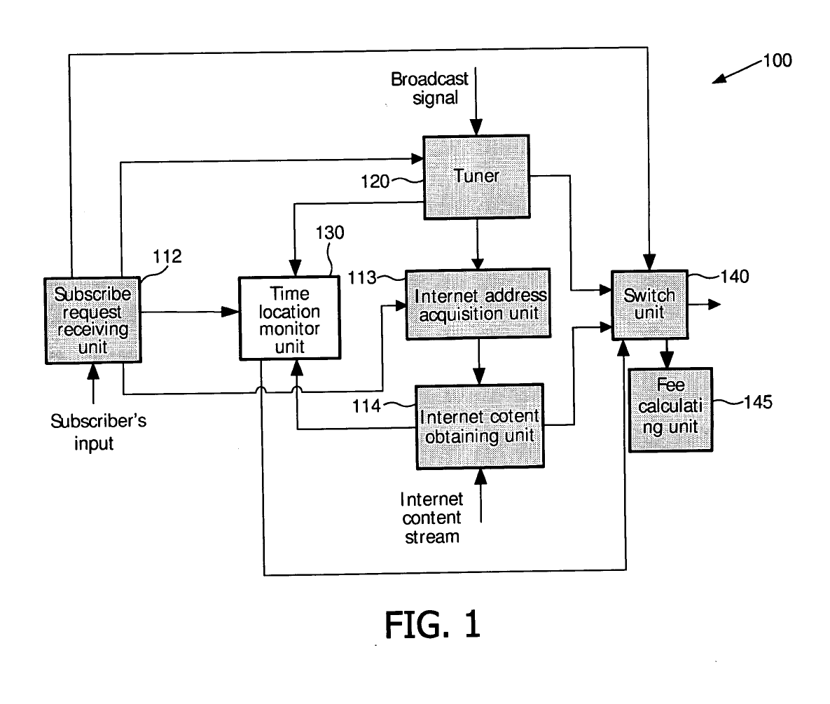

FIG. 1 is an block diagram of the components of an apparatus for playing back a program according to one example of the present invention. The apparatus 100 comprises a user request receiving unit 112, an internet address acquisition unit 113, and an internet content obtaining unit 114. Apparatus 100 also comprises a tuner 120, a time location monitor unit 130, a switch unit 140, and a fee calculating unit 145.

The user request receiving unit 112 is used for receiving a subscriber's request, and a subscriber can input his request with a remote control (not shown in the FIG. 1) The request may be the same channel choice request as in the prior art, and a request on a program being broadcast from a subscriber. The request requires playing back a section of the program at non-real time, for example pausing, rewinding, fast winding, and fast rewinding, and playing the program at a non-real-time broadcast time point of the program. The remote control of the present invention has the keys for the corresponding functions.

Tuner 120 is used for receiving a broadcast signal containing a program being broadcast. When the request received by subscriber request receiving unit 112 is a channel choice request, tuner 120 receives the corresponding broadcast signal according to the request. The broadcast signal can be broadcast to a user's terminal by territorial, cable or satellite unit.

Internet address acquisition unit 113 is used for acquiring a corresponding internet address according to the information in the broadcast signal of the broadcast program. When a subscriber's request is received, the request is one from a subscriber on the program being broadcast, which requires for playing back a section of the program a non-real time, internet address acquisition means 113 acquires an internet address according to and upon proper processing of the information, and stores the section having non-real time broadcast at the internet address. For example, the internet address is a section links to the current time point of the pre-stored program of the program being broadcast.

If the internet address is from an EPG, then the EPG may be pre-stored. If the internet address is from the program mapping table of the program, the program mapping table has been received by tuner 120 together with the program content.

Internet content obtaining unit 114 is used for obtaining section of the non-real time broadcast according to the internet address acquired by internet address acquisition unit 113 for playing back. Internet content acquisition unit 114 acquires, in stream media mode, the section of the non-real time broadcast to realize random or seamless switch between the part broadcast and that being broadcast of a program that has been broadcast.

Switch unit 140 is used for switching between the tuner 120 and the internet content acquisition unit 114 according to the request from a subscriber received by the subscriber request receiving unit 112 to choose between channels and between the real-time playback section and the non-teal time playback section of the same program according to the needs of the subscriber.

Time location monitor unit 130 is used for monitoring the current playback time point of the non-real time program section and that of the program being broadcast so as to notify switch unit 140 to resume the normal broadcast playback at a particular time point. That is, notify tuner 120 to receive broadcast signal to acquire program. For example, the section of the non-real time broadcast precedes the time point of the program being broadcast, and the playback of the section of the non-real time broadcast is in the fast-winding mode. In this case, time location monitor unit 130 compares the current playback time point of the non-real time program section with that of the program being broadcast. If the comparison shows that they are equivalent, then resumes the normal broadcast playback. Of course, time location monitor unit 130 may also notify, at a subscriber's request, switch unit 140 to switch from the broadcast playback to internet non-real time section playback. For example, a subscriber chooses, with the remote control, to pause for a period of time resumes program playback. At the time, time location monitor unit 130 will notify switch unit 140 to switch the source of program playback from the tuner to internet content stream.

Fee calculating unit 145 is used for obtaining the length of the time for playing back the non-real time program section from switch unit 140, and calculating the fees for the non-real time playback, which is different from the rate of fees for broadcast playback.

The functions of some unit contained in unit 100 (e.g. time location monitor unit 130 and internet address acquisition unit 113) can be performed by software. As far as those skilled in the art are concerned, said unit contained in unit 100 can be realized by a variety of existing unit provided that their combination can perform the functions of the present invention.

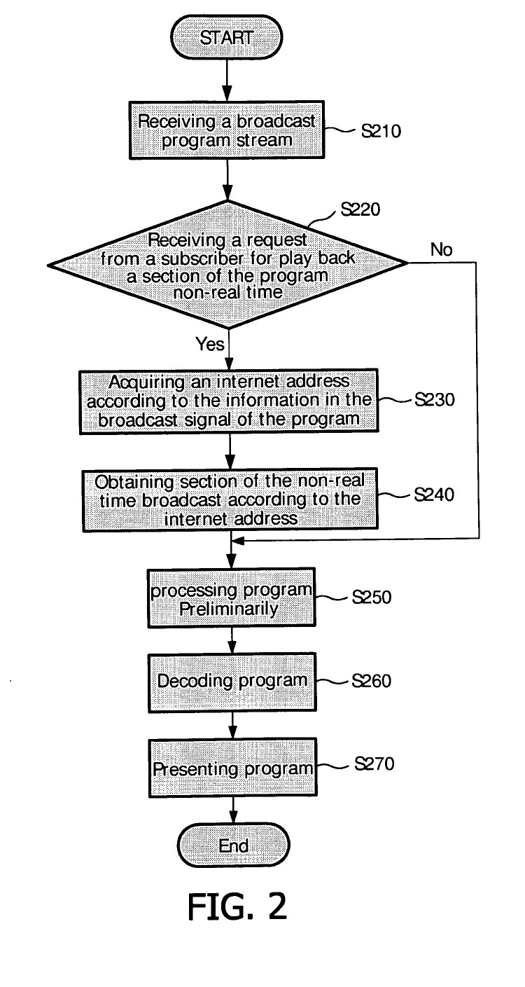

FIG. 2 is a flow chart of playback of a program according to another example of the present invention. The program is a program being broadcast.

First, receiving a broadcast program stream (step S210). The broadcast signal carrying the broadcast program stream can be transmitted to a subscriber's terminal by territorial, cable and satellite unit. The broadcast signal may have a plurality of broadcast program streams, and subscribers can view them by choosing a program being broadcast through channel switch.

Next, determining whether a request on a program being broadcast is received from a subscriber and whether the request is for playing back a section of the program non-real time (step S220).

The request is for playing back the program at a particular time point of the program, and the particular time point is different from the current time point of the program in the broadcast signal. For example, the broadcast of the program has reached the point of 37:00 minute in the broadcast signal, but the subscriber requests to play it at the point of 24:00 minute. The particular time point may be a time point broadcast (say, 24:00 minute), or a time point not broadcast (say 50:00 minute).

The request may also be rewinding to play the program. A subscriber is viewing the program through the signal channel, and he can play all the broadcast program part in rewinding mode by inputting a rewinding request.

Of course, the request may also be in other non-real time playback modes, such as fast winding, fast rewinding or pause, etc.

If the result of the determining step (step S220) is Yes, acquiring a corresponding internet address according to information in the broadcast signal of the program (step S230).

The internet address is from an EPG, which may be pre-stored, or transmitted to a subscriber's terminal through broadcast signal together with the program, for example, transmitted to a subscriber's terminal through the event information table (EIT).

When a user's request is received for playing back a section of the program non-real time acquiring in said broadcast signal, the channel number of the program and the program identification number; acquiring said internet address in the EPG list according to the channel number and program identification number.

The internet address may also come from the Program Mapping Table (PMT), or the EIT. The broadcaster may place the internet address in a particular verbal section of a particular table of service information (e.g. PMT) if necessary, and as pre-agreed, provided that the internet address can be found at a subscriber's terminal according to the agreement.

The internet address is the whole or partial content of the program being broadcast links to the pre-storage, e.g. a broadcast part. When only the broadcast part is stored in the internet address, a subscriber cannot choose to view a part not broadcast.

After acquiring the internet address, obtaining the non-real time broadcast section according to the internet address (step S240). The section is obtained on the internet in stream media mode. Thus, a subscriber can conduct random and seamless switch, without feeling the difference in the source of program as if he were operating a program locally stored. Of course, the section may also be obtained by downloading.

After that, processing the program preliminarily (step S250). As for non-real time broadcast section, the preliminary processing may include storing part of the non-real time broadcast program content in a buffer preliminarily in order to reduce the effect of fluttering of the internet broadband.

Of course, the result of the determining step (step 220) is No, then going directly from step S220 to step S250, that is processing the received broadcast signal stream preliminarily. At the same time, the preliminary processing includes demultiplex of the broadcast signal stream.

Finally, decoding the preliminarily processed program (step S260) and presenting the decoded program to a subscriber (step S270).

In the above work flow, calculate, through monitoring the length of the time for non-real time playing back the program section, the fees for the non-real time playback, which is different from the rate of fees for broadcast playback.

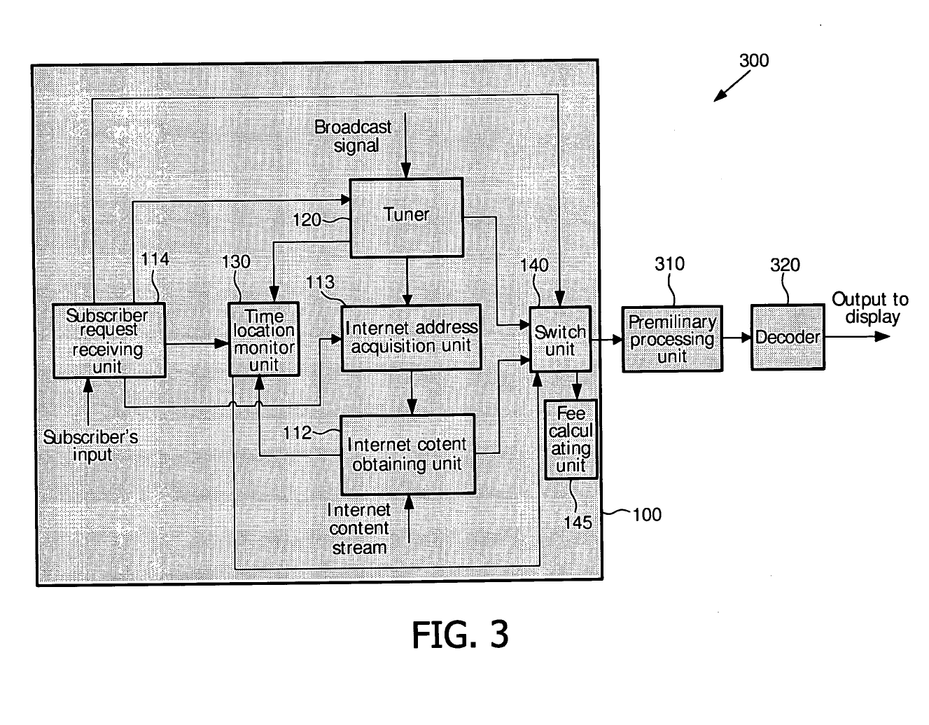

FIG. 3 is an block diagram of the components of a television set-top box according to another example of the present invention. Apparatus 300 comprises apparatus 100 and decoder 320. Apparatus 300 may includes preliminary processing unit 310, and also include a condition visit unit (not shown in the FIG. 3) and a storage unit (not shown in the FIG. 3).

Preliminary processing unit 310 processes the output of apparatus 100 for decoding by decoder 320. Preliminary processing unit 310 may include a demultiplexer (not shown in the FIG. 3) and a buffer (not shown in the FIG. 3). When the output of unit 100 is a broadcast signal stream, preliminary processing unit 310 can demultiplex the broadcast signal stream through preliminary processing unit 310. When unit 100's output is an internet content stream, preliminary processing unit 310 can pre-store part of the program content in the buffer with the buffer during the playing back the non-real time broadcast section for providing decoder 320 enough content data when flittering of the internet broadband arises.

Decoder 320 is used for decoding the program and the non-real time broadcast section. When apparatus 100 outputs a broadcast signal stream, decoder 320 is used for decoding a program being broadcast; when unit 100 outputs an internet content stream, decoder 320 is used for decoding an internet content stream.

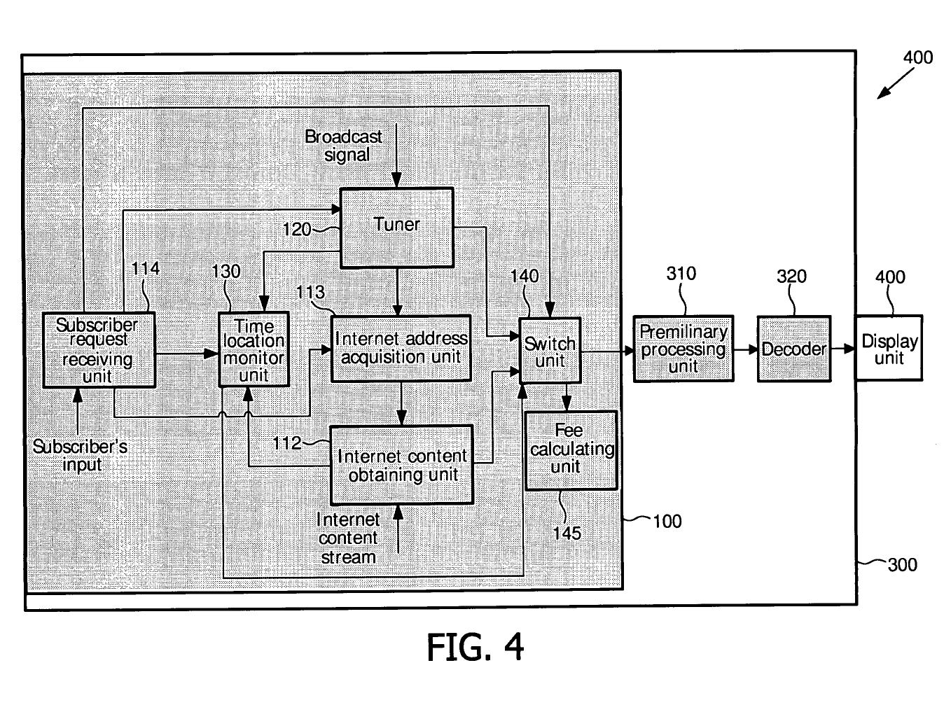

FIG. 4 is an block diagram of the components of a television set according to anther example of the present invention. apparatus 400 includes unit 300 and display unit 400.

Display unit 400 is used for presenting the output of unit 300 to a subscriber. Of course, it can also be used for presenting program information (such as, EPG) and interactive information (such as the current time point of the program being broadcast and a time point of non-real time playback input by a subscriber), etc.

The present invention has been described above in combination with the embodiments. It is evident that those skilled in the art can obviously make all sorts of substitutions, modifications and changes on the basis of what has been described above. For that matter; all substitutions, modifications and changes of the nature should be in the spirit, and fall within the scope, of the claims of the present invention.

1. A method for playing back a program, comprising the steps of:
a. receiving a request on the program being broadcast for playing back a section of the program in non-real-time mode from a subscriber;
b. acquiring a corresponding internet address according to information in the broadcast signal of the program; and
c. obtaining the section according to the internet address for playing back.

2. The method according to claim 1, further comprising the step of playing back the section.

3. The method according to claim 1, wherein the request includes one of the following commands: pause, fast winding, fast rewinding, rewinding, and playing back the program at a designated time point.

4. The method according to claim 1, wherein the section precedes the current time point of the program being broadcast.

5. The method according to claim 4, wherein the request is fast winding from designated time point, further comprising the steps of:
comparing current time point of playing back the section with the current time point of the program being broadcast;
if the comparison results are equivalent, playing back the program from broadcast signal.

6. The method according to claim 1, wherein the internet address is in a program mapping table.

7. The method according to claim 1, wherein the internet address is in the Electronic Program Guide, step (b) comprising the steps of:
acquiring channel number and program identification number from the broadcast signal;
acquiring the internet address in the Electronic Program Guide according to the channel number and program identification number.

8. The method according to claim 1, wherein the internet address links to a pre-stored program.

9. The method according to claim 1, wherein the internet address links to the section preceding to the current time point of the pre-stored program being broadcast.

10. The method according to claim 1, also comprising the step of:
d. calculating fees for playing back the program in non-real-time mode according to the length of time of the section, wherein the rate of fees for playing back in non-real-time mode is different from that for broadcasting.

11. An apparatus for playing back a program, comprising:
means for receiving a request on the program being broadcast for playing back a section of the program in non-real-time mode from a subscriber;
means for acquiring a corresponding internet address according to information in the broadcast signal of the program; and
means for obtaining the section according to the internet address for playing back.

12. The apparatus according to claim 11, further comprising means for monitoring current time point of playing back the section and current time point of the program being broadcast so as to resume the program being broadcast at a particular time point.

13. The apparatus according to claim 11, further comprising
a tuner for receiving a broadcast signal containing a program;
means for switching between the tuner and internet content acquisition means.

14. The apparatus according to claim 11, further comprising means for calculating fees for playing back the program in non-real-time mode according to the length of time of the section, wherein the rate of fees for playing back in non-real-time mode is different from that for broadcasting.

15. A set-top box, comprising:
a tuner for receiving a broadcast signal containing a program;
an apparatus for playing back the program, comprising:
means for receiving a request on the program being broadcast for playing back a section of the program in non-real-time mode from a subscriber;
means for acquiring a corresponding internet address according to information in the broadcast signal of the program; and
means for obtaining the section according to the internet address for playing back;
means for switching between the tuner and the internet content acquisition means; and
a decoder for decoding the program and the non-real time program section.

16. A television set, comprising:
a tuner for receiving a broadcast signal containing a program;
an apparatus for playing back the program, comprising:
means for receiving a request on the program being broadcast for playing back a section of the program in non-real-time mode from a subscriber;
means for acquiring a corresponding internet address according to information in the broadcast signal of the program; and
means for obtaining the section according to the internet address for playing back;
means for switching between the tuner and the internet content acquisition means;
a decoder for decoding the program and the non-real time program section;
means for presenting decoded program and section.
